(19) United States
(12) Patent Application Publication
(10) Pub. No.: US 2007/0042745 A1
(43) Pub. Date: Feb. 22, 2007

(54) Wireless communication device

(75) Inventor: Masao Tezuka, Tokyo (JP)

Correspondence Address: BAKER & MCKENZIE LLP;PATENT DEPARTMENT, 2001 ROSS AVENUE, SUITE 2300, DALLAS, TX, 75201, US

(73) Assignee: TDK CORPORATION, Tokyo (JP)

(21) Appl. No.: 11/427,248

(22) Filed: Jun. 28, 2006

(30) Foreign Application Priority Data
Jun. 28, 2005 (JP) 2005-188740

(51) Int. Cl. H04B 1/16

(52) U.S. Cl. 455/343.1

(57) ABSTRACT

A wireless communication device relays data between a USB terminal of a computer, and a peripheral device which is usually connected to the USB terminal. The wireless communication device has a DC power input terminal connected to an external power source, and a DC power output terminal connected to the peripheral device. A art of the power input to the DC power input terminal is used for driving the wireless communication device and another part of the power is supplied to the peripheral device via the DC power output terminal.

### BACKGROUND OF THE INVENTION

1. Field of the Invention

The present invention relates to a wireless communication device which relays data to be input to or output from a computer peripheral device, etc.

2. Description of the Related Art

A USB (Universal Serial Bus) is widely used as the interface that connects a computer and its peripheral device. Recently, standards for making the USB interface wireless (wireless USB) have been developing.

The wireless USB pursues realization of wireless USB 2.0 based on UWB (Ultra Wide Band). The MB-OFDM (Multi Band-OFDM) scheme established by the MBOA (Multi Band OFDM Alliance) is adopted as the specifications of the wireless USB.

In a case where a computer and its peripheral device are connected by wireless communications such as the wireless USB, etc., a wireless communication device which relays data communications between the computer and the peripheral device is required.

FIG. 12 shows the structure of a data communication system using a conventional wireless communication device.

The wireless communication system of FIG. 12 comprises a computer 1, a hard disk drive device (HDD) 2 as a computer peripheral device, and a wireless communication device 3 which relays data between these. The wireless communication device 3 is connected to the hard disk drive device 2 via a USB cable 4.

The data wirelessly sent from the computer 1 is received by the wireless communication device 3, and is supplied to the hard disk drive device 2 via the USB cable 4. The output data from the hard disk drive device 2 is supplied to the wireless communication device 3 via the USB cable 4, and is wirelessly sent to the computer 1.

The wireless communication device 3 is supplied with power via an alternating current (AC) adaptor 6 which is connected to an external power source by a plug 5. The hard disk drive device 2 is supplied with power from an external power source via a plug 7 and an AC adaptor 8.

It is also possible to supply power from the wireless communication device 3 to the hard disk drive device 2 via the USB cable 4. However, there is a limit in the amount of power that can be supplied via the USB. Therefore, the hard disk drive device 2 or the like that requires a large current needs power feeding to be done independently from done through the USB.

As described above, the data communication system utilizing the conventional wireless communication device has an AC adaptor and a plug for each device. This has raised a problem that there are many plugs and AC adaptors, and wire laying works become complicated.

Similar problems commonly occur when a plurality of devices are connected through a wireless communication device.

### SUMMARY OF THE INVENTION

Accordingly, an object of the present invention is to provide a wireless communication device which can simplify the system structure when it is connected to a computer peripheral device or the like.

Another object of the present invention is to provide a wireless communication device which requires a less number of plugs and AC adaptors than required in a conventional wireless communication device.

To achieve the above objects, a wireless communication device according to the present invention relays data between a first device which performs data communication wirelessly, and a second device which performs communication with the first device, and comprises:

a power input unit which is supplied with power;

a first communication unit driven by the power supplied to the power input unit, for performing data communication with the first device wirelessly;

a second communication unit driven by the power supplied to the power input unit, for performing data transfer with the second device; and

a power supply unit which supplies a part of the power supplied to the power input unit to the second device.

The wireless communication device may further comprise a data transfer cable which connects the second communication unit and the second device, for transferring data between the wireless communication device and the second device.

The wireless communication device may further comprise a power supply cord which connects the power supply unit and the second device, for supplying power to the second device.

The wireless communication device may comprise a data transfer cable which connects the second communication unit and the second device, for transferring data between the wireless communication device and the second device; and a power supply cord which connects the power supply unit and the second device, for supplying power to the second device.

The power input unit may include an adaptor which converts an alternating-current power supplied from a power source into a direct-current power and the first communication unit may be driven by the direct-current power supplied from the adaptor; and the power supply unit may supply a part of the direct-current power supplied to the power input unit to the second device.

A plurality of second devices may be prepared. In this case, the wireless communication device may comprise a plurality of data transfer cables; the power supply unit may supply power to the plurality of second devices to drive them; and the second communication unit may transfer data to the plurality of second devices via the plurality of data transfer cables.

A plurality of first devices may be prepared. In this case, the first communication unit may perform data communication with the plurality of first devices wirelessly.

The wireless communication device may further comprise a detection unit which detects whether the data transfer cable is connected to the second communication unit or not; and a control unit which performs a control of activating the first communication unit, when the detection unit detects that the data transfer cable is connected to the second communication unit.

The power input unit, the first and second communication units, and the power supply unit may be incorporated in a common housing and the housing may have an engaging portion which engages with the second device.

The wireless communication device may comprise a first connector and a second connector, wherein the communication connection unit is connectable to connector of a communication unit of the second device and the wireless communication device can communicate with the second device through the first connector, and the second connector is connectable to a connector of a power input portion of the second device, and the wireless communication device can send power to the second device through the second connector.

The data transfer cable and the power supply cord may be structured into one body.

The first device may be a computer, a storage device or a printer.

The above-described objects and other objects of the present invention, and novel characteristics of the present invention will become more completely apparent upon reading of the following detailed description with reference to the attached drawings. It should be noted, however, that the drawings are intended solely for explanation, and not to limit the present invention.

### BRIEF DESCRIPTION OF THE DRAWINGS

A preferred form of the present invention is illustrated in the accompanying in which:

FIG. 1 is a block diagram of a computer system utilizing a wireless communication device according to an embodiment of the present invention;

FIG. 2 is a block diagram showing a structure of the wireless communication device according to an embodiment of the present invention;

FIG. 3 is an external view of the wireless communication device;

FIG. 4 is an external view of a hard disk drive device;

FIG. 5 is a side elevation showing a state that the hard disk drive device is attached on the wireless communication device;

FIG. 6A is a flowchart for explaining a power source control process performed by a control unit when the wireless communication device and the hard disk drive device are connected by a USB cable;

FIG. 6B is a flowchart for explaining a power source control process performed by the control unit when the wireless communication device and the hard disk drive device having been connected to each other are disconnected.

FIG. 7 is a block diagram showing an example of a wireless communication device in which a plurality of DC power output terminals and a plurality of wireless communication units are prepared;

FIG. 8 is a block diagram showing an example of a structure in which power is supplied from the wireless communication device to a printer;

FIG. 9 is a block diagram showing an example that a USB cable and a power source cable are integrated;

FIG. 10 is a block diagram showing an example that the wireless communication device includes an AC adaptor;

FIG. 11 is a side elevation showing an example that the wireless communication device and the hard disk drive device are connectable directly; and

FIG. 12 is a block diagram for explaining the problem of the conventional wireless communication device: a schematic diagram showing a system utilizing the conventional wireless communication device.

### DETAILED DESCRIPTION OF THE PREFERRED EMBODIMENT

A computer system 100 utilizing a wireless communication device 10 according to an embodiment of the present invention will be explained below.

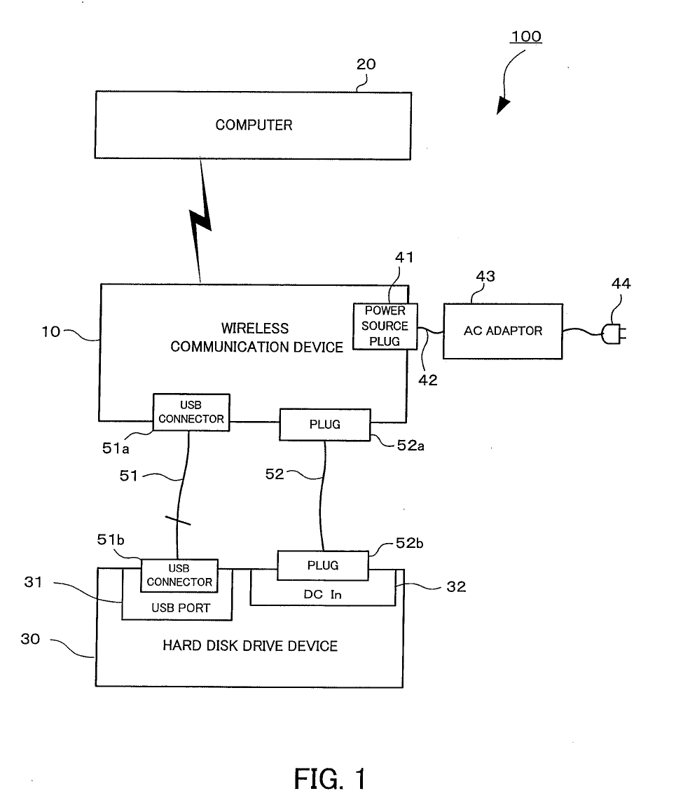

As shown in FIG. 1, the computer system 100 according to the present embodiment comprises a wireless communication device 10, a computer 20, and a hard disk drive device 30.

The computer 20 performs data processing by using the hard disk drive device 30 as an external storage device.

The hard disk drive device 30 comprises a USB (Universal Serial Bus) port 31 and a direct current (DC) power source terminal (DC In) 32.

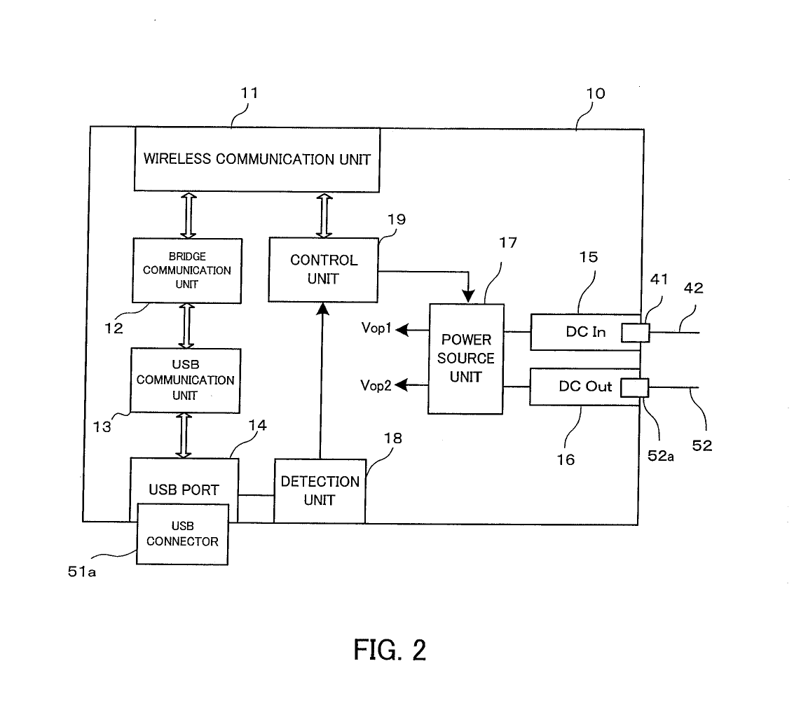

The USB port 31 is a port for sending data to external device and receiving data from the external device with a USB. A USB connector 51b is detachably connected to the USB port 31. The USB port 31 is connected to a USB port 14 (FIG. 2) of the wireless communication device 10 via the USB connector 51b attached thereto, a USB cable 51, and a USB connector 51a.

The DC power source terminal (DC In) 32 is supplied with electrical power (a direct current operation voltage) for operating the hard disk drive device 30. A plug 52b is detachably connected to the DC power source terminal (DC In) 32. The DC power source terminal (DC In) 32 is supplied with DC power (DC voltage) for driving the hard disk drive device 30 via the plug 52b attached thereto, a power source cable 52, and a plug 52a.

The wireless communication device 10 relays data between the computer 20 and the hard disk drive device 30.

As shown in FIG. 2, the wireless communication device 10 comprises a wireless communication unit 11, a bridge communication unit 12, a USB communication unit 13, a USB port 14, a DC power input terminal (DC In) 15, a DC power output terminal (DC Out) 16, a power source unit 17, a detection unit 18, and a control unit 19.

The wireless communication unit 11 receives data wirelessly sent from the computer 20, or sends data wirelessly to the computer 20.

The bridge communication unit 12 bridges data between the wireless communication unit 11 and the USB communication unit 13.

The USB communication unit 13 receives data, which is received by the wireless communication unit 11, via the bridge communication unit 12, and transfers the data to the USB port 14. Further, the USB communication unit 13 receives data from the USB port 14, and transfers the data to the wireless communication unit 11 via the bridge communication unit 12.

The USB connector 51a connected to one end of the USB cable 51 is detachably connected to the USB port 14. The USB port 14 transfers data sent from the USB communication unit 13 to the hard disk drive device 30 via the USB connector 51a and the USB cable 51, or transfers data sent from the hard disk drive device 30 via the USB cable 51 to the USB communication unit 13.

The DC power input terminal 15 is a power source voltage terminal through which DC power is externally input, and a power source plug 41 is connected thereto. An (AC) adaptor 43 for converting an AC voltage into DC voltage is connected to the power source plug 41 via a power source cord 42 and supplies electrical power to the DC power input terminal 15. A plug 44 is connected to the AC adaptor 43. When the plug 44 is connected to a commercial AC power source, power is supplied to the DC power input terminal 15. The AC adaptor 43 has an enough capacity to drive the wireless communication unit 11 and the hard disk drive device 30.

The power source unit 17 comprises a switching regulator or the like, converts a DC voltage supplied from the DC power input terminal 15 into operation voltages Vop1 and Vop2, and applies the operation voltage Vop1 to the detection unit 18, the control unit 19, and the DC power output terminal (DC Out) 16 and applies the operation voltage Vop2 to the wireless communication unit 11, the bridge communication unit 12, and the USB communication unit 13. The power source unit 17 has a sufficient capacity for driving the wireless communication unit 11, the bridge communication unit 12, the USB communication unit 13, the detection unit 18, the control unit 19, and the hard disk drive device 30.

The DC power output terminal 16 is connected to the power source cable 52 whose one end is connected to the DC power source terminal 32 of the hard disk drive device 30, and supplies a DC voltage sent from the power source unit 17 to the hard disk drive device 30.

The detection unit 18 comprises a micro switch, a photo coupler, and the like, and detects whether the USB connector 51a of the USB cable 51 is connected to the USB port 14 or not. The detection unit 18 transmits a detection signal indicating the detection result (presence or absence of attachment of the USB connector 51a) to the control unit 19. It is arbitrary to detect whether or not the USB connector 51a is connected to the USB port 14. For example, the detection unit 18 may detect attachment of the USB connector 51a to the USB port 14 in accordance with pull-up or pull-down of a predetermined line or lines (for example, the ground line) of the USB port 14.

The control unit 19 is the controller of the wireless communication device 10. In response to a detection signal from the detection unit 18, the control unit 19 controls the power source unit 17 to generate and apply the operation voltage Vop2 to the wireless communication unit 11, the bridge communication unit 12, and the USB communication unit 13, when the USB connector 51a is connected to the USB port 14. By the operation voltage Vop2 being applied, the wireless communication unit 11, the bridge communication unit 12, and the USB communication unit 13 are activated. In contrast, in response to a detection signal from the detection unit 18, the control unit 19 controls the power source unit 17 to stop generating and applying the operation voltage Vop2 to the wireless communication unit 11, the bridge communication unit 12, and the USB communication unit 13 , when the USB connector 51a is not connected to the USB port 14.

In using the wireless communication device 10, the USB connector 51a attached to one end of the USB cable 51 is connected to the USB port 14 of the wireless communication device 10, and the USB connector 51b attached to the other end of the USB cable 51 is connected to the USB port 31 of the hard disk drive device 30, as shown in FIG. 1. Further, the plug 52a attached to one end of the power source cable 52 is connected to the DC power output terminal (DC Out) 16 of the wireless communication device 10, and the plug 52b attached to the other end of the power source cable 52 is connected to the DC power source terminal 32 of the hard disk drive device 30.

Furthermore, the power source plug 41 connected to the AC adaptor 43 via the power source cord 42 is connected to the DC power input terminal 15 of the wireless communication device 10, and the plug 44 of the AC adaptor 43 is connected to a commercial power source.

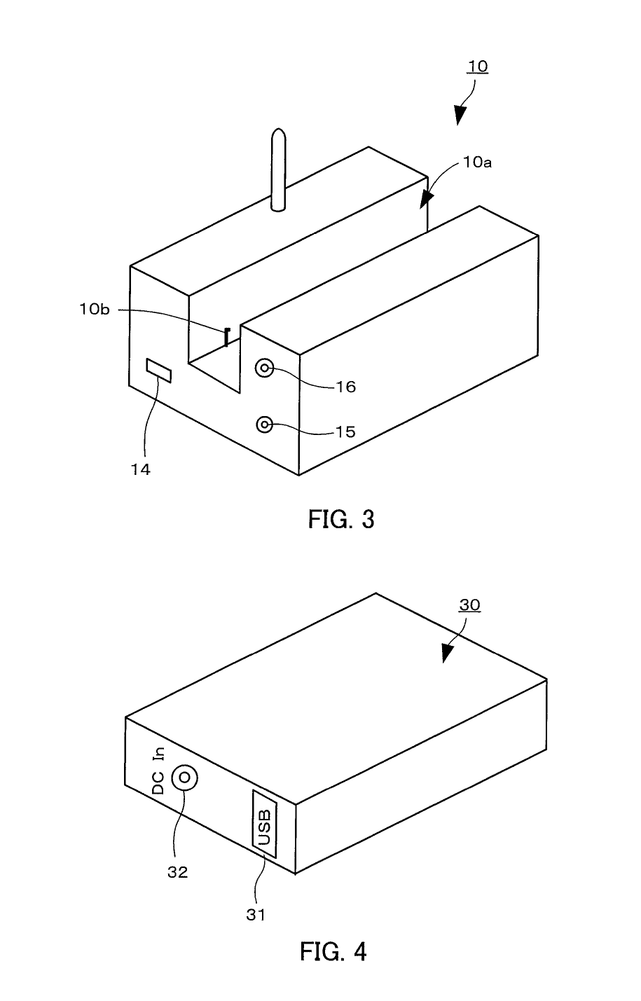

As shown in FIG. 3, a groove 10a is formed in the upper surface of the wireless communication device 10. The hard disk drive device 30 having an external shape shown in FIG. 4 is detachably attached to the groove 10a. A clamping member 10b such as a hook, etc. for preventing the hard disk drive device 30 from falling off is provided inside the groove 10a.

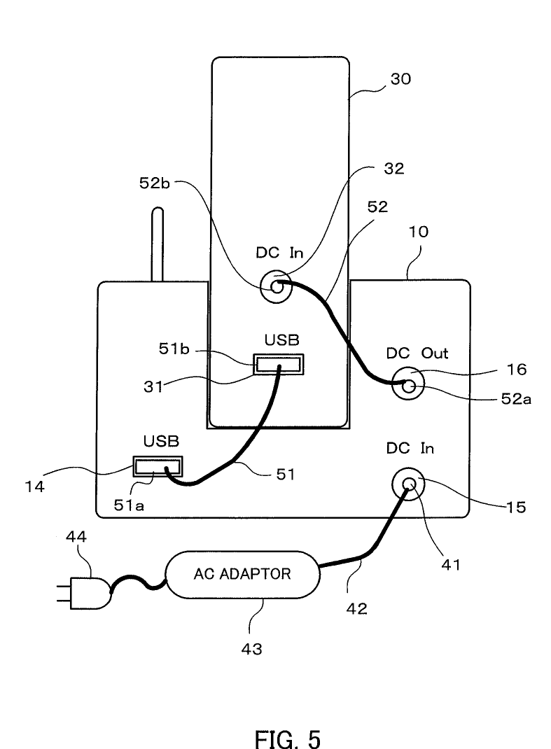

FIG. 5 shows a side elevation of a state that the hard disk drive device 30 is attached on the wireless communication device 10, the hard disk drive device 30 and the wireless communication device 10 are connected by the cables 51 and 52, and the AC adaptor 43 is connected to the wireless communication device 10. As shown in FIG. 5, the wireless communication device 10 and the hard disk drive device 30 are assembled integrally.

Next, the operation of the computer system 100 having the above-described structure will be explained.

When the plug 44 is connected to a commercial AC power source, AC voltage is converted by the AC adaptor 43 into DC voltage. The converted DC voltage is supplied to the power source unit 17 via the power source cord 42 and the plug 41, and further via the DC power input terminal (DC In) 15. The power source unit 17 starts operating by the supplied DC voltage, generates the operation voltage Vop1, and applies it to the detection unit 18 the control unit 19, and the DC Power output terminal (DC Out) 16. In response to this, the detection unit 18 and the control unit 19 start operating. Further, the operation voltage Vop1 is applied to the DC power source terminal (DC In) 32 of the hard disk drive device 30 from the DC power output terminal 16 via the plug 52a, the power source cable 52, and the plug 52b. That is, the electrical power for driving the hard disk drive device 30 is supplied from the wireless communication device 10 to the hard disk drive device 30 via the power source cable 52.

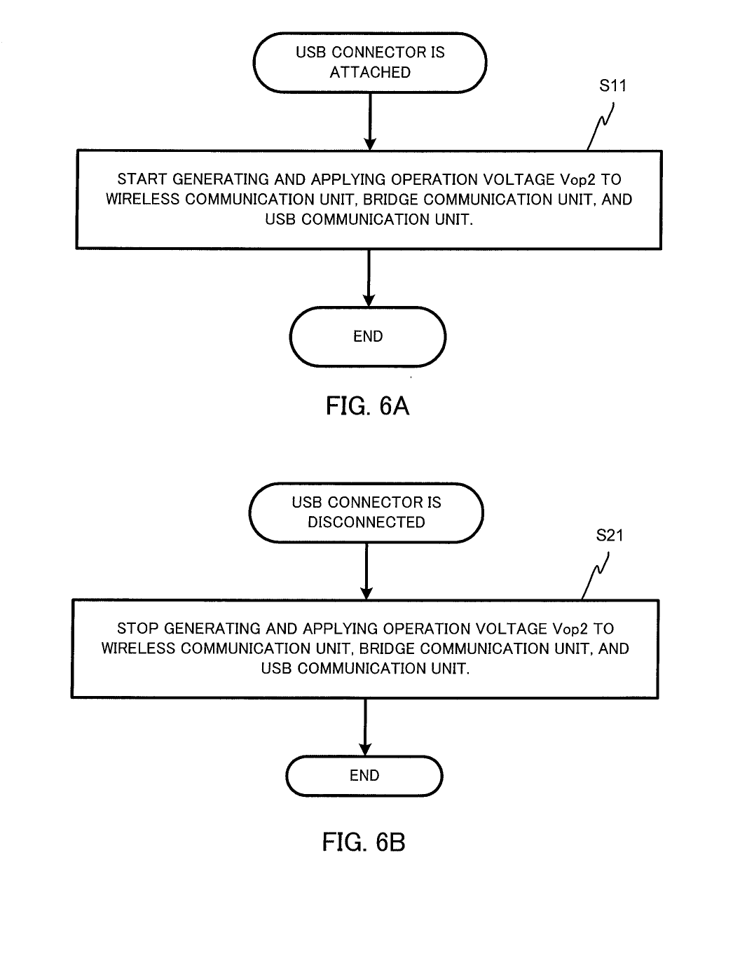

When the hard disk drive device 30 and the USB port 14 are connected by the USB cable 51, the detection unit 18 outputs a detection signal to the control unit 19. In response to the detection signal, the control unit 19 starts a power source control process shown in FIG. 6A, and controls the power source unit 17 to supply operation voltage Vop2 to the wireless communication unit 11, the bridge communication unit 12, and the USB communication unit 13 (step S11). In response to this, these circuits are activated to enable wireless communications between the computer 20 and the wireless communication device 10.

When the computer 20 sends data (including a command) to the hard disk drive device 30 in the state that the computer 20 and the wireless communication device 10 are enabled to communicate wirelessly, the data sent from the computer 20 is received by the wireless communication unit 11 of the wireless communication device 10. The data received by the wireless communication unit 11 is transferred to the USB port 14 via the bridge communication unit 12 and the USB communication unit 13. The data is further transferred to the hard disk drive device 30 via the USB connector 51a, the USB cable 51, the USB connector 51b, and the USB port 31. As a result, the data is written on a hard disk held in the hard disk drive device 30. Data sent from the hard disk drive device 30 is transferred to the USB port 14 of the wireless communication device 10 via the USB cable 51. The data is further transferred to the wireless communication unit 11, and sent from the wireless communication unit 11 to the computer 20. As a result, the data is read into the computer 20 from the hard disk held in the hard disk drive device 30.

When the USB connector 51a is detached from the USB port 14, a detection signal notifying the detachment is supplied to the control unit 19. In response to this detection signal, the control unit 19 starts a power source control process shown in FIG. 6B, and controls the power source unit 17 to stop generating and applying the operation voltage Vop2 having been supplied to the wireless communication unit 11, the bridge communication unit 12, and the USB communication unit 13 (step S21). This inactivates these circuits, making wireless communications between the computer 20 and the wireless communication device 10 impossible.

As explained above, a DC voltage (operation power) is supplied from the DC power output terminal 16 of the wireless communication device 10 to the hard disk drive device 30. Therefore, it is possible to supply operation power to both the wireless communication device 10 and the hard disk drive device 30 by using one AC adaptor. Accordingly, it is possible to reduce the numbers of AC adaptors and plugs as compared to the prior art. Further, since the wiring becomes simple, the computer system 100 can have a simpler structure.

The present invention is not limited to the above-described embodiment, but can be modified in various manners.

For example, in the embodiment, the output voltage (power) of the power source unit 17 is applied to the hard disk drive device 30. The voltage applied to the DC power input terminal (DC In) 15 may be applied to the DC power output terminal (DC Out) 16 directly. In this case, the drive ability of the power source unit 17 is enough to drive internal circuits of the wireless communication device 10. The AC adaptor 43 has to have a drive ability enough to drive both the wireless communication device 10 and the hard disk drive device 30. In other words, if the wireless communication device 10 can supply a part of the power supplied to the wireless communication device 10 to the hard disk drive device 30, the structures of them are arbitrary.

For example, there may be a plurality of computers 20. In this case, the wireless communication device 10 receives data from the plurality of computers 20, and transfers the received data from the USB port 14 to the hard disk drive device 30. Further, the wireless communication device 10 transmits data transferred from the hard disk drive device 30 to the plurality of computers 20 from the wireless communication unit 11. At this time, by varying the frequency to be used, the time slot, etc. computer by computer, it is possible to prevent a conflict of data from the plurality of computers 20.

Further, a plurality of DC power output terminals (DC Out) 16 (16₁ to 16ₙ) may be prepared so that the operation power may be supplied from the wireless communication device 10 to a plurality of hard disk drive devices. In this case, there are also a plurality of USB ports 14 (14₁ to 14ₙ) prepared, and the USB ports 14 of the wireless communication device 10 and the plurality of hard disk drive devices are connected by a plurality of USB cables 51 (51₁ to 51ₙ).

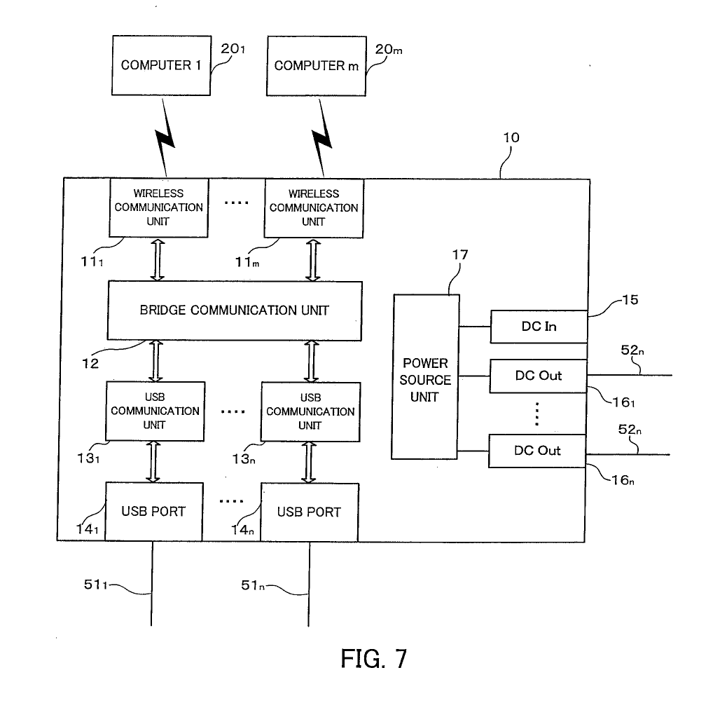

FIG. 7 shows example of the internal structure of the wireless communication device 10 which has a plurality of wireless communication units 11 (11₁ to 11ₘ), a plurality of USB communication units 13 (13₁ to 13ₙ), a plurality of USB ports 14 (14₁ to 14ₙ), and a plurality of DC Out 16 (16₁ to 16ₙ). The wireless communication units 11 (11₁ to 11ₘ) and the USB communication units 13 (13₁ to 13ₙ) are connected by the bridge communication unit 12 with each other so as to allow communication between arbitrary one of the computers 20 (20₁ to 20ₘ) and the arbitrary one of the hard disk drive device 30 (30₁ to 30ₙ).

In the above-described embodiment, an example has been shown that the groove 10a is formed in the wireless communication device 10, and the wireless communication device 10 and the hard disk drive device 30 are integrated by setting the hard disk drive device 30 in the groove 10a. The present invention is not limited to this example. For example, a recess or protrusion having an arbitrary shape may be formed on the surface of the wireless communication device 10 and a protrusion or recess matching these may be formed on the surface of the hard disk drive device 30, so that the wireless communication device 10 and the hard disk drive device 30 may engage. Other attaching methods may be employed. However, it is desired that such a method do not necessitate other members and devices than the wireless communication device 10 and the hard disk drive device 30.

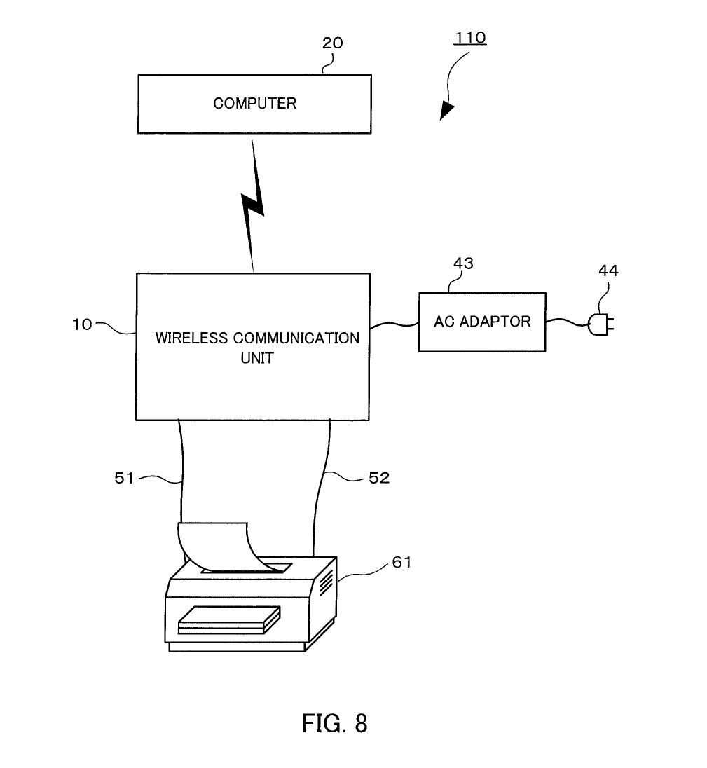

The peripheral device to be connected to the computer 20 via the wireless communication device 10 may be other than the hard disk drive device 30, and may be, for example, a printer 61 as shown in FIG. 8. Other than this, the present invention can be applied to various circuits for sending data to a computer and receiving data from a computer via a USB.

A USB has been employed as an example of a scheme of data communication between the wireless communication device 10 and the peripheral device of the computer 20. Other data communication schemes may be employed. In this case, the USB communication unit 13 and the USB port 14 are replaced with ones that match the communication scheme employed, respectively.

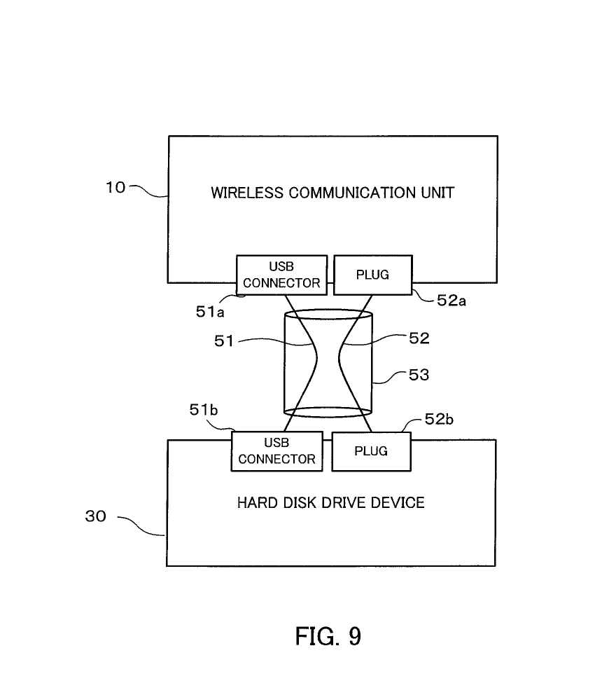

Furthermore, the USB port 14 and the DC power output terminal 16 may be arranged closely to use a cable 53 which is the integration of the USB cable 51 and the power source cable 52 as shown in FIG. 9.

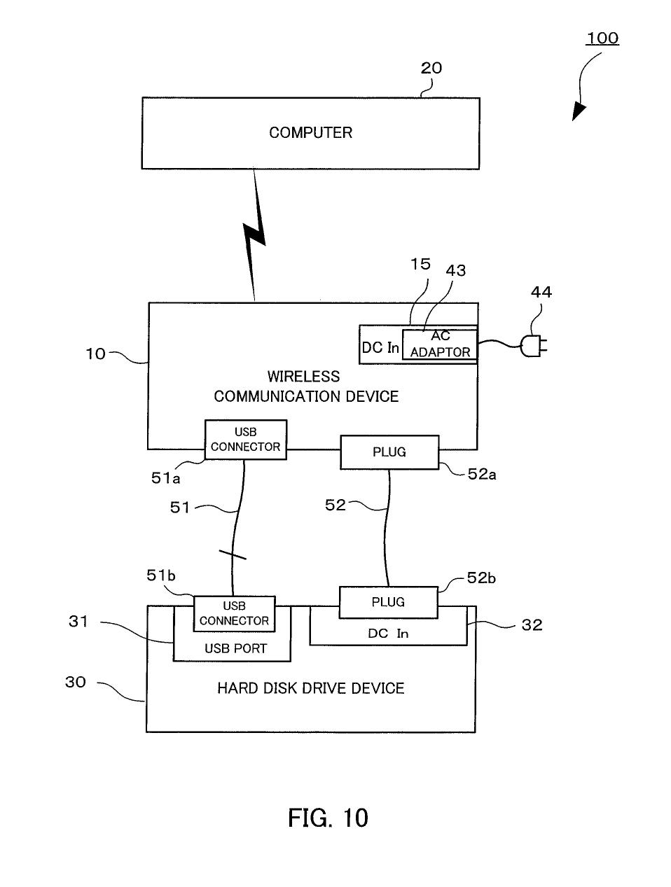

Furthermore the AC adaptor 43 may be incorporated inside the wireless communication device 10. The DC power input terminal 15 may include the AC adaptor 43 as shown in FIG. 10.

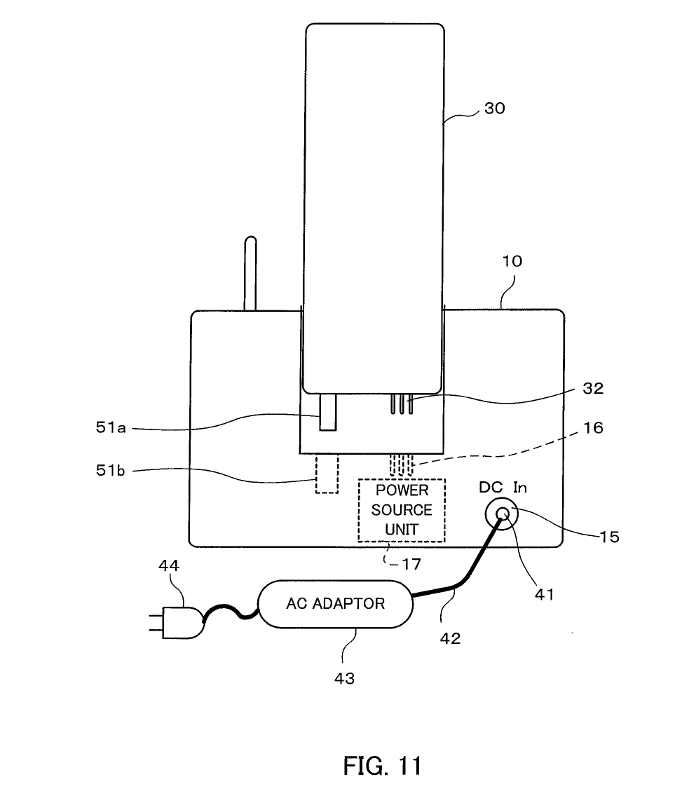

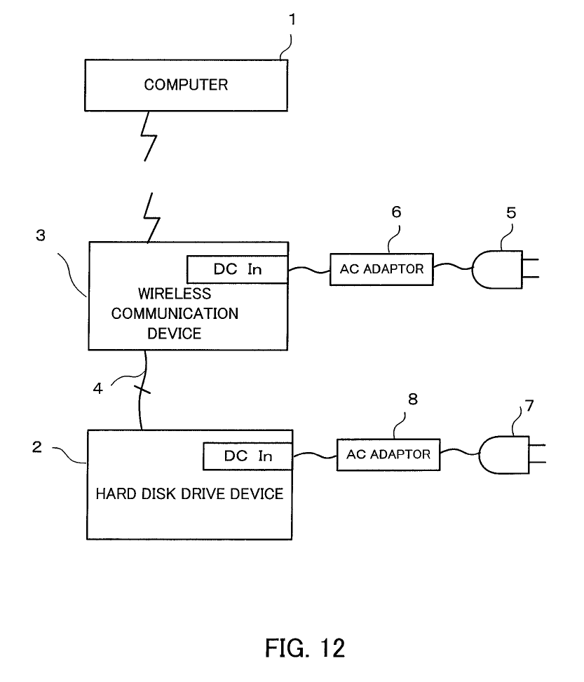

The USB port 14 and DC power output terminal 16 of the wireless communication device 10 and the USB port 31 and DC power source terminal 32 of the hard disk drive device 30 may be directly connected without any cables when the wireless communication device 10 and the hard disk drive device 30 are engaged. For example, FIG. 11 shows an example of such a structure. When the hard disk drive device 30 is inserted into the recess or groove 10a of the wireless communication device 10, the plug(s) and/or connector(s) 32, 51a of the hard disk drive device 30 are directly and automatically connected with the connector(s) and/or plug (s) 16, 51b of the wireless communication device 10 so that the wireless communication device 10 can supply electrical power to and communicate with the hard disk drive device 30. The structure of the plug(s) and connector(s) are arbitrary.

Various embodiments and changes may be made thereunto without departing from the broad spirit and scope of the invention. The above-described embodiment is intended to illustrate the present invention, not to limit the scope of the present invention. The scope of the present invention is shown by the attached claims rather than the embodiment. Various modifications made within the meaning of an equivalent of the claims of the invention and within the claims are to be regarded to be in the scope of the present invention.

This application is based on Japanese Patent Application No. 2005-188740 filed on Jun. 28, 2005 and including its specification, claims, drawings and summary. The disclosure of the above Japanese Patent Application is incorporated herein by reference in its entirety.

What is claimed is:

1. A wireless communication device for relaying data between a first device which performs data communication wirelessly, and a second device which performs communication with said first device, said wireless communication device comprising:
a power input unit which is supplied with power;
a first communication unit driven by the power supplied to said power input unit, for performing data communication with said first device wirelessly;
a second communication unit driven by the power supplied to said power input unit, for performing data transfer with said second device; and
a power supply unit which supplies a part of the power supplied to said power input nit to said second device.

2. The wireless communication device according to claim 1, further comprising a data transfer cable which connects said second communication unit and said second device, for transferring data between said wireless communication device and said second device.

3. The wireless communication device according to claim 1, further comprising a power supply cord which connects said power supply unit and said second device, for supplying power to said second device.

4. The wireless communication device according to claim 1, further comprising:
a data transfer cable which connects said second communication unit and said second device, for transferring data between said wireless communication device and said second device; and
a power supply cord which connects said power supply unit and said second device, for supplying power to said second device.

5. The wireless communication device according to claim 1,
wherein: said power input unit includes an adaptor which converts an alternating-current power supplied from a power source into a direct-current power;
said first communication unit is driven by the direct-current power supplied from said adaptor; and
said power supply unit supplies a part of the direct-current power supplied to said power input unit to said second device.

6. The wireless communication device according to claim 2,
wherein: a plurality of second devices are prepared, and said wireless communication device comprises a plurality of data transfer cables;
said power supply unit supplies power to said plurality of second devices to drive them; and
said second communication unit transfers data to said plurality of second devices via said plurality of data transfer cables.

7. The wireless communication device according to claim 1,
wherein: a plurality of first devices are prepared; and
said first communication unit performs data communication with said plurality of first devices wirelessly.

8. The wireless communication device according to claim 2, further comprising:
a detection unit which detects whether said data transfer cable is connected to said second communication unit or not; and
a control unit which performs a control of activating said first communication unit, when said detection unit detects that said data transfer cable is connected to said second communication unit.

9. The wireless communication device according to claim 1,
wherein: said power input unit, said first and second communication units, and said power supply unit are incorporated in a common housing; and
said housing has an engaging portion which engages with said second device.

10. The wireless communication device according to claim 1, further comprising a first connector and a second connector, wherein the communication connection unit is connectable to connector of a communication unit of the second device and the wireless communication device can communicate with the second device through the first connector, and the second connector is connectable to a connector of a power input portion of the second device, and the wireless communication device can send power to the second device through the second connector.

11. The wireless communication device according to claim 4,
wherein said data transfer cable and said power supply cord are structured into one body.

12. The wireless communication device according to claim 1,
wherein said first device is a computer.

13. The wireless communication device according to claim 1,
wherein said second device is a storage device or a printer.
